(19) United States
(12) Patent Application Publication
(10) Pub. No.: US 2026/0266324 A1
(43) Pub. Date: Sep. 10, 2026

(54) BOLT-WASHER ASSEMBLY FOR ATTACHING TRUCK BODY TO FRAME, METHOD AND APPARATUS FOR ASSEMBLING THE BOLT-WASHER ASSEMBLY

(71) Applicant: Agrati Inc., Park Forest, IL (US)

(72) Inventor: David BORK, Rochester Hills, MI (US)

(21) Appl. No.: 19/555,718

(22) Filed: Mar. 3, 2026

Related U.S. Application Data
(60) Provisional application No. 63/766,704, filed on Mar. 4, 2025.

(51) Int. Cl. F16B 35/00; F16B 39/22; F16B 43/00

(52) U.S. Cl. CPC F16B 35/00; F16B 39/225; F16B 43/00

(57) ABSTRACT

A bolt and washer assembly adapted for the purpose of mounting automotive body structures to frame structures includes a flanged head high strength bolt, a metal load distributing washer, and a plastic retaining washer. A method for assembling a bolt and washer assembly, adapted for the purpose of mounting automotive body structures to frame structures, includes the following steps: forging a high strength bolt having a flanged head, stamping a metal load distributing washer, stamping a plastic retaining washer, and assembling a metal load distributing washer and a plastic retaining washer to the bolt. An apparatus for pre-assembling a bolt and washer assembly is configured to: insert the bolt into the metal load distributing washer, and insert the bolt, coupled with the metal load distributing washer, into the plastic retaining washer by pressing the plastic retaining washer along the bolt's axial direction.

### BACKGROUND OF THE INVENTION

Body-on-frame is a vehicle construction method in existence since the earliest automobiles. This method of construction is still used today mainly for trucks and large SUVs due to the advantages in strength, durability, and payload and towing capacities. In order to improve ride quality in these vehicles, elastomer bushings are used to insulate the body where it mounts to the frame. In addition to providing insulating characteristics, these joints are required to be robust in terms of developing and maintaining clamp load. To accomplish this, high strength bolts are used. However, the elastomer bushings are not able to support the pressure created by these high clamp loads and the surface area provided by standard flanged bolt heads. In order to distribute the clamp load over the large surface of the elastomer bushings, flat washers are used that have diameters multiple times larger than the bolt head diameter.

Current vehicle assembly practice requires both fastener components (bolt, large diameter washer) to be stocked on the assembly line. When ready for installation, an assembly operator must obtain each component separately and hand-assemble the washer to the bolt prior to installing the bolt through the bushing into the vehicle. This requires labor time for assembly and presents potential for quality issues in case the operation is missed, and no washer is installed. Additionally, the vehicle manufacturer must procure and stock multiple part numbers on the assembly line, leading to further inefficiencies. It is therefore desirable to provide the bolt and washer for this application as an assembly.

Bolt and washer assemblies are known technology, however typical methods of capturing washers with rolled threads are not feasible due to the large diameter of the required washer. Such an assembly would cause manufacturing issues during heat treatment and coating. These issues would include nicked threads, bent bolts, and coating defects. Additionally, bolts with washers of this size would occupy much more volume during all operations and transport, further reducing manufacturing efficiency. Attempting to manufacture in this manner would negate any cost and quality improvements offered by the assembly.

### BRIEF SUMMARY OF THE INVENTION

A primary object of the invention is to improve the assembly of body to frame vehicles by reducing costs and reducing potential quality issues. This objective is accomplished by providing a bolt and washer assembly that is economical to produce and does not impair the bolt or washer performance.

Commensurate with the stated objective, the invention consists of an assembly of three separate components each designed to carry out the unique functions required to mount the automotive body to the frame.

The described bolt is a high strength steel fastener with flanged head for distributing clamp load. The bolt optionally consists of a shoulder underneath the head for centering purposes, a reduced diameter body, a threaded section for engagement into the application, a locking element to resist loosening, and point features to improve alignment and prevent cross threading during assembly.

Said bolt is assembled together with a high strength steel load distributing washer. This washer has a large outer diameter in order to clamp the elastomeric bushing used in such applications and an inner diameter sized to permit free assembly over the bolt threads.

To retain the steel washer to the bolt after all manufacturing steps are performed, a retaining washer is applied after the steel washer is assembled onto the bolt. This retaining washer is manufactured from a low hardness plastic in order to not damage bolt threads, the pre-applied locking element, or corrosion resistant coatings. However, the material and specific geometry of said retaining washer are designed such that sufficient force is required to remove it so as to retain the steel washer during transportation and assembly into the vehicle.

This retention method is lightweight, durable, and resilient, which allows for multiple removals and assemblies as needed while retaining function. If required, the components can be disassembled manually, without the need for additional tools or presses. In addition, abrasion of the retainer material can provide beneficial rather than detrimental effects on the bolt threads.

As described, the current invention allows for an assembly that fulfills all of the requirements of a durable fastened connection between an automotive body and frame while lowering assembly costs and improving both threaded fastener and final assembly quality.

The present description relates to a bolt and washer assembly adapted for the purpose of mounting automotive body structures to frame structures. The bolt and washer assembly comprises a flanged head high strength bolt, a metal load distributing washer, and a plastic retaining washer.

According to an aspect of the description, the metal load distributing washer is retained between the flanged head of the bolt and the plastic retaining washer.

According to an aspect, the bolt has a flanged head for load distribution, a shoulder underneath the head for washer centering and retaining washer interference, a reduced diameter body for washer translation, a locking element to resist loosening, and a piloting feature to ease assembly and prevent cross-threading. Preferably, the locking element is polyamide based, for example a reusable nylon type, or is micro-encapsulated epoxy based, for example a micro-encapsulated pre-applied adhesive.

The bolt, for example, has threads and the flanged head of the bolt has a diameter twice as large as the diameter of the threads.

Preferably, the high strength bolt is a bolt manufactured out of medium carbon or alloy steel, heat treated to a minimum tensile strength of 1040 MPa.

According to an aspect of the description, the metal load distributing washer is sized to distribute the clamping load over an elastomeric bushing and thickness optimized to distribute load while minimizing weight.

Preferably, the metal load distributing washer is manufactured from medium carbon steel, in particular, with hardness that meets or exceeds the bolt hardness to resist indentation.

Preferably, the metal load distributing washer has an outer diameter length between three and six times the thread of the bolt.

Preferably, the metal load distributing washer has a thickness between 2 mm and 6 mm, in order to provide sufficient resistance to bending while minimizing weight.

According to an aspect of the description, the plastic retaining washer is manufactured with external diameter sizing so as not to interfere with mating components, and internal diameter sizing, tab geometry, and thickness to provide interference during installation and retention onto said bolt.

Preferably, the plastic retaining washer is manufactured from High-Density Polyethylene, HDPE, or from Nylon.

Preferably, the plastic retaining washer is stamped or molded by injection.

Preferably, the plastic retaining washer is manufactured with six tabs. The plastic retaining washer may be designed with more or less tabs than six.

Preferably, the plastic retaining washer has a thickness of 1.5 mm. the thickness can be adjusted to provide varying levels of retention force.

According to an aspect of the description, the bolt and washer assembly comprises a high strength bolt. The bolt comprises a flanged head, a cylindrical shoulder, threads and a cylindrical body. Threads have a diameter approximately equal to a diameter of the cylindrical shoulder. Cylindrical body has an unthreaded reduced diameter with respect to threads. The threads present a locking element applied thereto.

The bolt and washer assembly comprises a metal load distributing washer having an outer diameter which is multiple times the flange diameter and an inner diameter wider than the thread diameter and narrower than the flange diameter.

The bolt and washer assembly comprises a plastic retaining washer having six tabs. Tabs create a tab inner diameter smaller than the threads diameter and the shoulder diameter.

The metal load distributing washer and the plastic retaining washer are coupled with the bolt, so that the metal load distributing washer is retained between the flanged head of the bolt and the plastic retaining washer, and the plastic retaining washer is placed between the flange and the threads.

The description also relates to a method for assembling a bolt and washer assembly, adapted for the purpose of mounting automotive body structures to frame structures. The method comprises the following steps: forging a high strength bolt comprising a flanged head, stamping a metal load distributing washer, stamping a plastic retaining washer, assembling a metal load distributing washer and a plastic retaining washer to the bolt.

According to an aspect of the description, after the metal load distributing washer is assembled to the bolt, the plastic retaining washer is assembled to the bolt, so that the metal load distributing washer is retained between the flanged head of the bolt and the plastic retaining washer.

Preferably, the method comprises a step of rolling threads on the bolt. The step of rolling threads on the bolt is executed before the step of assembling the metal load distributing washer and the plastic retaining washer to the bolt.

According to an aspect of the description, the method comprises the following step, executed before the step of assembling the metal load distributing washer and the plastic retaining washer to the bolt: heat treating the bolt, applying coating on the heat-treated bolt, heat treating the metal load distributing washer, applying coating to the heat-treated metal load distributing washer.

Preferably, the method comprises the following steps: forging a high strength blank bolt comprising a flanged head, rolling threads on the bolt, heat treating the threaded bolt, applying coating on the heat-treated bolt, applying a locking element to the coated bolt, stamping a metal load distributing washer, heat treating the metal load distributing washer, applying coating to the metal load distributing washer, stamping a plastic retaining washer, assembling a metal load distributing washer to the threaded bolt, assembling a plastic retaining washer to the threaded bolt, so that the metal load distributing washer is retained between the flanged head of the bolt and the plastic retaining washer.

According to an aspect of the description, the method comprises a step of feeding the threaded bolt, the coated metal load distributing washer and the plastic retaining washer into an assembly apparatus. The step of assembling metal load distributing washer to the threaded bolt and assembling plastic retaining washer to the threaded bolt is executed by the assembly apparatus.

The description also relates to an apparatus, that is an assembly equipment, for pre-assembling a bolt and washer assembly. The apparatus is designed to receive a flanged head high strength bolt, a metal load distributing washer and a plastic retaining washer. The apparatus is configured to insert the bolt into the metal load distributing washer. The apparatus is configured to insert the bolt, coupled with the metal load distributing washer, into the plastic retaining washer by pressing the plastic retaining washer along the bolt's axial direction.

### BRIEF DESCRIPTION OF THE DRAWINGS

These and other features and advantages of the present invention will become more readily appreciated when considered in connection with the following detailed description and appended drawings, wherein:

FIG. 1 is a side view of the body mounting bolt;

FIG. 2 is a top view of the metal load distributing washer;

FIG. 3 is a side view of the metal load distributing washer;

FIG. 4 is a top view of the plastic retaining washer;

FIG. 5 is a side view of the plastic retaining washer;

FIG. 6 is a side view of the bolt washer assembly, with washers in position 1;

FIG. 7A is a side view of the bolt washer assembly, with washers in an alternate position; and

FIG. 7B is a side view of the bolt washer assembly, showing further variation of washers in the alternate position;

FIG. 8A and 8B are side views of the body mounting bolt, according to different embodiments;

FIG. 9 is a is a schematic flow diagram of one embodiment of the method for assembling a bolt and washer assembly.

### DETAILED DESCRIPTION OF THE INVENTION

Referring to the figures, wherein like numerals indicate like or corresponding parts throughout the several views, the following text describes the current invention that attempts to solve the current manufacturing and assembly issues when attaching an automotive body to a frame structure. As previously described, this assembly application provides for a number of different demands on the fastener. It must be robust in order to generate and maintain significant clamp loads, it must accommodate assembly with elastomeric bushings, it must provide characteristics to resist loosening after assembly, it must have high corrosion resistance, it must be simple to assemble, and it must be economical to produce. The present invention provides accommodations for all of these requirements through a number of preferred embodiments as described herein.

Referring to FIG. 1, the bolt 10 of the present invention is produced from steel through the process of cold forming and heat treated to achieve a nominal tensile strength of 1040 MPa. The bolt 10 has a flange 11 that may vary in size, but serves to distribute clamp load. The size and type of driving feature 12 may also vary based on the preferred assembly method. The bolt 10 optionally contains a cylindrical shoulder 13, a cylindrical and unthreaded reduced diameter body 14, and threads 15 that may vary in size and pitch depending on the required application. The length of these features may be adjusted to suit different assembly requirements. The diameter of the shoulder 13 is substantially similar to the diameter of the threads 15 and provides centering of the load distributing washer 20. A locking element 16 is applied to the threads 15, and this locking element 16 may be polyamide based or micro-encapsulated epoxy based. At the extreme end of the bolt 10 there is a feature 17 to provide for alignment and a feature 18 to resist cross-threading during assembly.

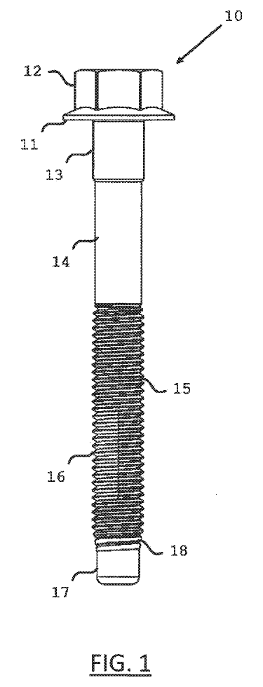

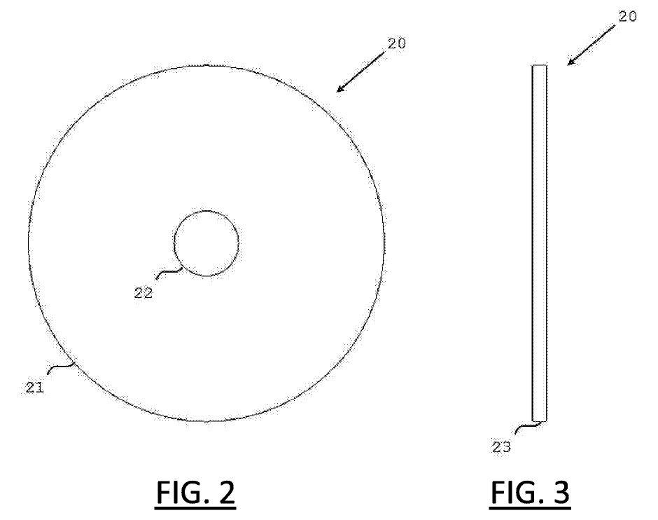

Referring to FIGS. 2 and 3, the metal load distributing washer 20 is shown with a cylindrical outer diameter 21 that is multiple times the bolt flange 11 diameter and sized based on application requirements. The cylindrical inner diameter 22 is sized for free assembly over the bolt threads 15. The thickness 23 of the washer is such that load is properly distributed, but weight is minimized. The washer 20 is made of medium carbon steel and heat treated in order to resist compression during application of clamp load during tightening of the bolt 10.

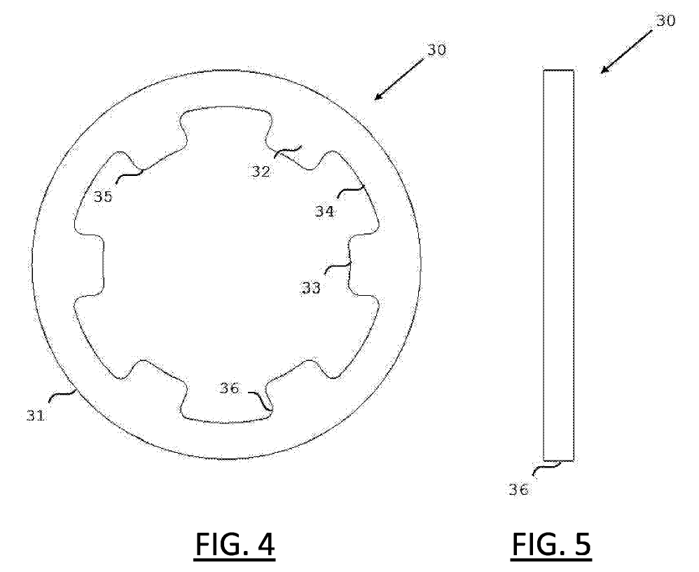

Referring to FIGS. 4 and 5, the plastic retaining washer 30 is shown with a cylindrical outer diameter 31 that is sized to ensure no interference of mating components once installed in the application. The washer 30 is designed with six tabs 32 that have a height, created by the difference between tab inner diameter 33 and the washer inner diameter 34 so as to create a tab inner diameter 33 that is sized so as to be smaller than the bolt thread 15 diameter and shoulder diameter 13 to create interference during installation and prevent removal unless by force. This force of assembly and removal may be adjusted by adjusting the width of the tabs 32, the curved radius on the tab corners 35, and/or thickness 36 of the washer 30. The material of the washer 30 is plastic, and the specific resin is chosen such that the washer is resilient to installation and removal, but also is of low enough hardness so that there is no damage to bolt threads 15, bolt locking element 16 or the corrosion resistant coatings. In fact, abrasion of the washer 30 during installation may deposit small particles to improve lubricity of the bolt threads 15. The radius of intersection 37 of the tabs 32 to the washer inner diameter 34 is designed to minimize stresses during installation and removal.

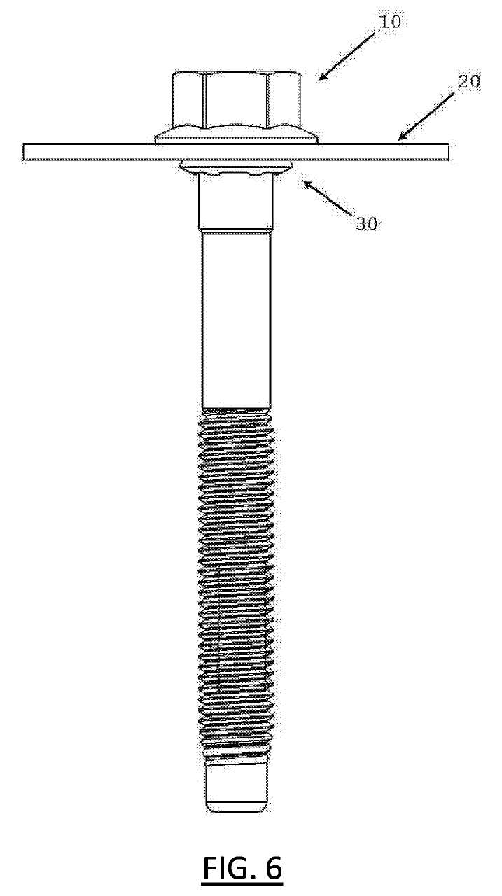

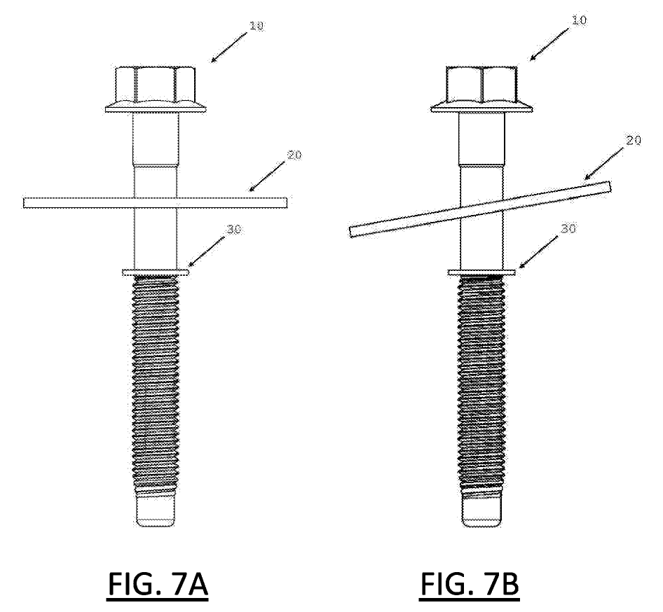

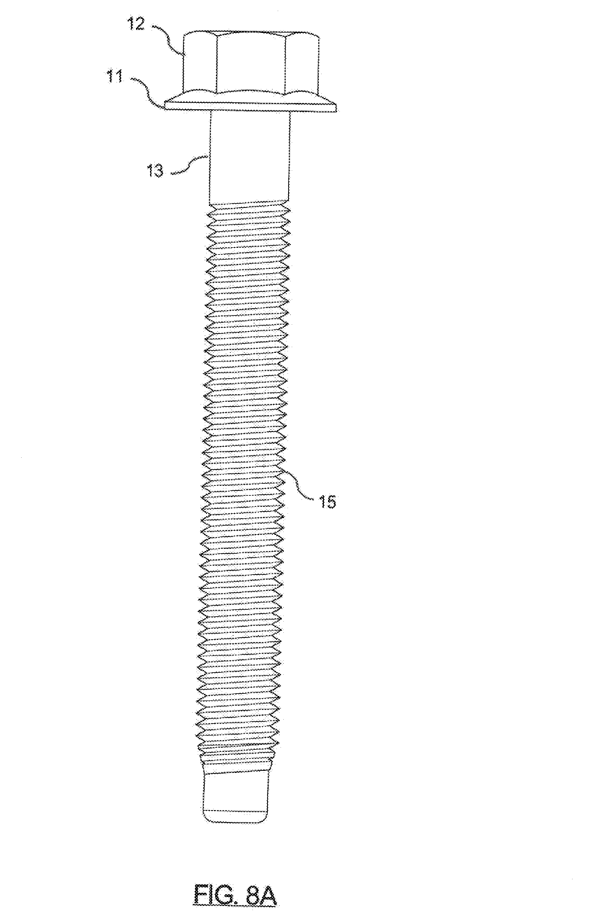

FIGS. 6, 7A, and 7B show the components assembled in various possible configurations. In FIG. 6 the plastic retaining washer 30 is assembled fully, such that the metal load distributing washer 20 is held tight to the bolt flange 11. As seen in the figure, the plastic retaining washer 30 has been deflected, and the tabs 32 remain in direct contact with the bolt shoulder 13. In this configuration, the metal load distributing washer 20 cannot move axially up and down the bolt body 14, however it is not held by so much force so as to prevent relative rotation between the bolt 10 and metal washer 20. The force is sufficient to prevent noise and vibration due to relative movement between the bolt 10 and metal load distributing washer 20. In FIG. 7A, the plastic retaining washer 30 is assembled just beyond the bolt threads 15 so that it is captured and cannot be removed without applying an axial force. In this configuration, the metal load distributing washer 20 is free to move in an axial direction between the bolt flange 11 and retaining washer 30 while also rotating freely about the bolt axis. An advantage in this configuration is shown in FIG. 7B where the difference in diameter between the metal washer inner diameter 22 and the bolt reduced body diameter 14 allows the washer to pivot in addition to translating. This configuration allows the most flexibility of the components and provides the ability for fasteners to nest together to minimize volume during packaging and transportation.

The utility of the invention is the ability to perform all manufacturing steps of the bolt 10 and metal load distributing washer 20 prior to the assembly of said components. The bolt manufacturing steps include cold forming, thread rolling, heat treatment, application of corrosion resistant coating, and application of the locking element. The manufacturing steps of the metal washer 20 include stamping, heat treatment, and application of corrosion resistant coating. After both components are fully manufactured, the metal load distributing washer 20 is oriented onto the bolt body 14, and the plastic retaining washer 30 is pressed on to the point of either FIGS. 6 or 7A and 7B as desired. This assembly is then delivered to the automotive assembly line, where an assembly operator is able to obtain a single component (assembly) and place it into use.

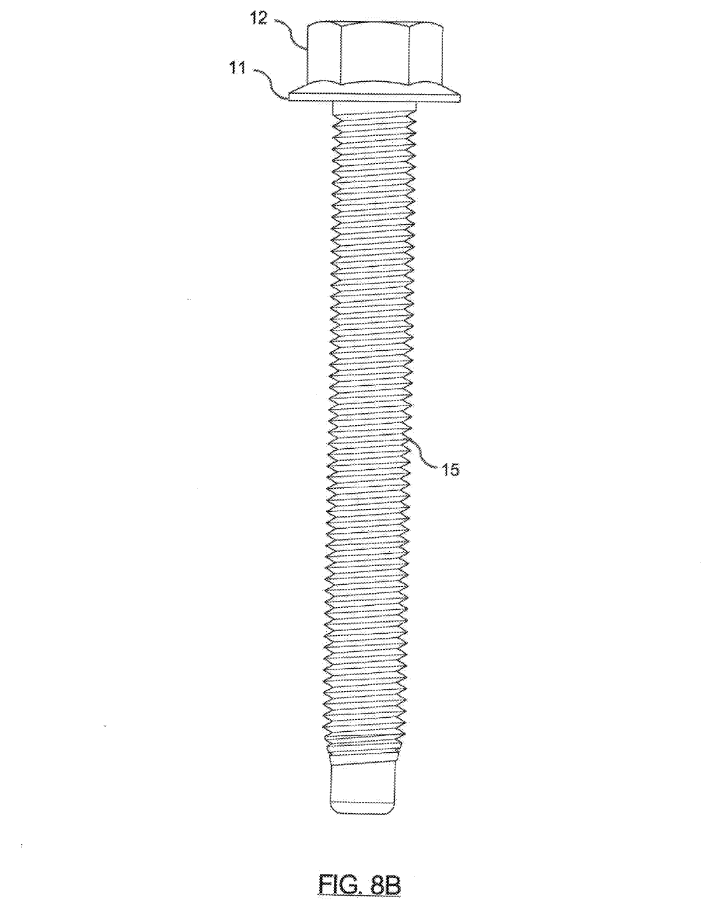

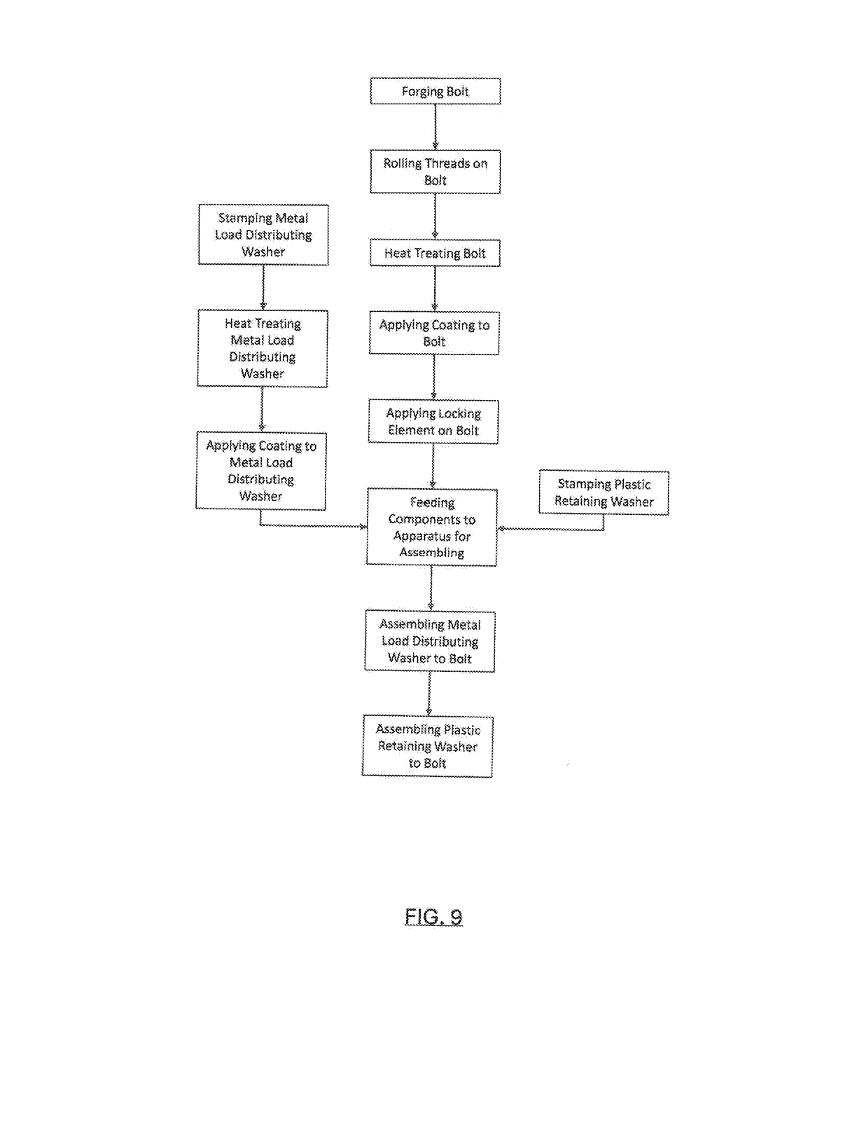

In an embodiment, as shown in FIG. 8A, threads 15 of the bolt 10 extends towards the flange 11 of the head of the bolt 10. In particular, the bolt 10, according to this embodiment, does not have the unthreaded reduced diameter body 14, or has it for a minimal space. The locking element 16 can be applied to threads 15.

In an embodiment, as shown in FIG. 8B threads 15 of the bolt 10 extends towards the flange 11 of the head of the bolt 10. In particular, the bolt 10, according to this embodiment, does not have neither the unthreaded reduced diameter body 14 nor the cylindrical shoulder 13, or, at least, the bolt 10 has the cylindrical shoulder 13 for a minimal space. The locking element 16 can be applied to threads 15.

In FIG. 9, it is shown a method for assembling a bolt and washer assembly, adapted for the purpose of mounting automotive body structures to frame structures, according to a preferred embodiment. The method comprises the following steps: forging a high strength blank bolt comprising a flanged head, rolling threads 15 on the bolt, heat treating the threaded bolt 10, applying coating on the heat-treated bolt 10, applying a locking element 16 to the coated bolt 10. The method comprises the following steps: stamping a metal load distributing washer 20, heat treating the metal load distributing washer 20, applying coating to the metal load distributing washer 20. The method comprises the step of stamping a plastic retaining washer 30. The method comprises the step of feeding the components, that are the threaded bolt 10, the coated metal load distributing washer 20 and the plastic retaining washer 30, into an apparatus for assembling. The method comprises the following steps: assembling a metal load distributing washer 20 to the threaded bolt 10, assembling a plastic retaining washer 30 to the threaded bolt 10, so that the metal load distributing washer 20 is retained between the flanged head of the bolt 10 and the plastic retaining washer 30.

In the preferred assembly sequence, the metal load distributing washer 20 is not retained until the final step when it is assembled along with the plastic retaining washer 30. This allows all of the preceding steps (such as heat treatment, coating, locking element application) to happen, respectively, on the individual components. Performing these steps as an assembly is not economically desirable, and can have functional disadvantages such as warped parts or damaged threads.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A bolt and washer assembly adapted for the purpose of mounting automotive body structures to frame structures comprising:
a flanged head high strength bolt,
a metal load distributing washer, and
a plastic retaining washer.

2. The bolt and washer assembly as recited in claim 1, wherein the metal load distributing washer is retained between the flanged head of the bolt and the plastic retaining washer.

3. The bolt and washer assembly as recited in claim 1, wherein the bolt has a flanged head for load distribution, a shoulder underneath the head for washer centering and retaining washer interference, a reduced diameter body for washer translation, a locking element to resist loosening, and a piloting feature to ease assembly and prevent cross-threading.

4. The bolt and washer assembly as recited in claim 3, wherein the locking element is polyamide based, for example a reusable nylon type, or is micro-encapsulated epoxy based, for example a micro-encapsulated pre-applied adhesive.

5. The bolt and washer assembly as recited in claim 1, wherein the bolt has threads and wherein the flanged head of the bolt has a diameter twice as large as the diameter of the threads.

6. The bolt and washer assembly as recited in claim 1, wherein the high strength bolt is a bolt manufactured out of medium carbon or alloy steel, heat treated to a minimum tensile strength of 1040 MPa.

7. The bolt and washer assembly as recited in claim 1, wherein the metal load distributing washer is sized to distribute the clamping load over an elastomeric bushing and thickness optimized to distribute load while minimizing weight.

8. The bolt and washer assembly as recited in claim 1, wherein the metal load distributing washer is manufactured from medium carbon steel.

9. The bolt and washer assembly as recited in claim 1, wherein the metal load distributing washer has:
an outer diameter length between three and six times the thread of the bolt, and
a thickness between 2 mm and 6 mm.

10. The bolt and washer assembly as recited in claim 1, wherein the plastic retaining washer is manufactured with external diameter sizing so as not to interfere with mating components, and internal diameter sizing, tab geometry, and thickness to provide interference during installation and retention onto said bolt.

11. The bolt and washer assembly as recited in claim 1, wherein the plastic retaining washer is manufactured from High-Density Polyethylene, HDPE, or from Nylon, and/or the plastic retaining washer is stamped or molded by injection.

12. The bolt and washer assembly as recited in claim 1, wherein the plastic retaining washer is manufactured with six tabs and/or the plastic retaining washer has a thickness of 1.5 mm.

13. The bolt and washer assembly as recited in claim 1, comprising:
a high strength bolt, the bolt comprising a flanged head, a cylindrical shoulder, threads having a diameter approximately equal to a diameter of the cylindrical shoulder, and a cylindrical body having an unthreaded reduced diameter with respect to threads, the threads presenting a locking element applied thereto,
a metal load distributing washer having an outer diameter which is multiple times the flange diameter and an inner diameter wider than the thread diameter and narrower than the flange diameter, and
a plastic retaining washer having six tabs creating a tab inner diameter smaller than the threads diameter and shoulder diameter,
the metal load distributing washer and the plastic retaining washer being coupled with the bolt, so that
the metal load distributing washer is retained between the flanged head of the bolt and the plastic retaining washer, and
the plastic retaining washer is placed between the flange and the threads.

14. A method for assembling a bolt and washer assembly, adapted for the purpose of mounting automotive body structures to frame structures, comprising the following steps:
forging a high strength bolt comprising a flanged head,
stamping a metal load distributing washer,
stamping a plastic retaining washer,
assembling a metal load distributing washer and a plastic retaining washer to the bolt.

15. The method according to claim 14, wherein, after the metal load distributing washer is assembled to the bolt, the plastic retaining washer is assembled to the bolt, so that the metal load distributing washer is retained between the flanged head of the bolt and the plastic retaining washer.

16. The method according to claim 14, comprising a step of rolling threads on the bolt, before the step of assembling the metal load distributing washer and the plastic retaining washer to the bolt.

17. The method according to claim 14, comprising the following steps, before the step of assembling the metal load distributing washer and the plastic retaining washer to the bolt:
heat treating the bolt,
applying coating on the heat-treated bolt,
heat treating the metal load distributing washer,
applying coating to the heat-treated metal load distributing washer.

18. The method according to claim 14, comprising the following steps:
forging a high strength blank bolt comprising a flanged head,
rolling threads on the bolt,
heat treating the threaded bolt,
applying coating on the heat-treated bolt,
applying a locking element to the coated bolt,
stamping a metal load distributing washer,heat treating the metal load distributing washer,
applying coating to the metal load distributing washer,
stamping a plastic retaining washer,
assembling a metal load distributing washer to the threaded bolt,
assembling a plastic retaining washer to the threaded bolt, so that the metal load distributing washer is retained between the flanged head of the bolt and the plastic retaining washer.

19. The method according to claim 18, comprising a step of feeding the threaded bolt, the coated metal load distributing washer and the plastic retaining washer into an assembly apparatus,
the steps of assembling metal load distributing washer to the threaded bolt and assembling plastic retaining washer to the threaded bolt being executed by the assembly apparatus.

20. An apparatus for pre-assembling a bolt and washer assembly, the apparatus being designed to receive a flanged head high strength bolt, a metal load distributing washer and a plastic retaining washer, the apparatus being configured to:
insert the bolt into the metal load distributing washer, and
insert the bolt, coupled with the metal load distributing washer, into the plastic retaining washer by pressing the plastic retaining washer along the bolt's axial direction.
